(19) United States
(12) Patent Application Publication
(10) Pub. No.: US 2025/0031869 A1
(43) Pub. Date: Jan. 30, 2025

(54) Carrier and stroller

(71) Applicant: Goodbaby Child Products Co., Ltd., Kunshan (CN)

(72) Inventors: Fusheng MA, KUNSHAN (CN); Pingzhong SHI, KUNSHAN (CN)

(21) Appl. No.: 18/917,513

(22) Filed: Oct. 16, 2024

(30) Foreign Application Priority Data
Nov. 20, 2023 (CN) 202311542224.0

(51) Int. Cl. A47D 13/02; B62B 7/12

(52) U.S. Cl. CPC A47D 13/02; B62B 7/12

(57) ABSTRACT

The present invention relates to a carrier and a stroller. The carrier has a folded state and an unfolded state. The carrier includes a first correlation structure and a second correlation structure. The carrier further includes two first supporting structures respectively connected to the first correlation structure, two second supporting structures respectively connected to the second correlation structure, a linkage structure disposed between the first supporting structure and the second supporting structure, and an actuation mechanism coupled to the first correlation structure and the second correlation structure. Each of the first supporting structures, each of the second supporting structures, and the linkage structure are folded inwards when the carrier is moved from the unfolded state to the folded state, so that the cloth cover disposed in the carrier receiving space can be received inside without being exposed and soiled.

### TECHNICAL FIELD

The present invention relates to the field of children's articles, and in particular to a carrier, and a stroller having the same.

### BACKGROUND ART

Some carriers currently on the market for carrying infants, such as children's sleeping baskets, usually have a receiving space for the infant to lie in, the circumference of which is provided with a cloth cover for protecting the infant. In order to facilitate daily storage and carrying, the carrier is usually designed as a foldable structure. In the prior art, the carrier can be usually folded along the length direction so as to reduce the volume. However, in the carriers disclosed in the patent documents, such as the ones with Publication Numbers CN207949456U, CN205548140U, CN204708434U, CN203693076U and so on, although the carrier can be folded along the length direction, the cloth cover in the receiving space after folding is usually exposed to the outside. In the process of daily storage and carrying, the cloth cover is very easy to be dirty, affecting the next use of the carrier.

### SUMMARY OF THE INVENTION

It is an object of the present invention to provide a new carrier that addresses one or more of the problems of the prior art.

In order to achieve the above-mentioned object, according to the technical solution adopted by the present invention, a carrier has a folded state and an unfolded state, the carrier comprising a first correlation structure and a second correlation structure. The carrier further comprises:
two first supporting structures, wherein each of the first supporting structures is respectively connected to the first correlation structure, and each of the first supporting structures rotatable with respect to each other;
two second supporting structures, wherein each of the second supporting structures is respectively connected to the second correlation structure, and each of the second supporting structures is rotatable with respect to each other;
a linkage structure disposed between the first supporting structure and the second supporting structure and movable with respect to at least one of the first supporting structure and the second supporting structure;
an actuation mechanism coupled to the first correlation structure and the second correlation structure, wherein when the carrier is in an unfolded state, the first correlation structure and the second correlation structure are locked by the actuation mechanism to locate the relative positions of each of the first supporting structures and each of the second supporting structures; when the carrier is transformed from the unfolded state into the folded state, the first correlation structure and the second correlation structure are unlocked by the actuation mechanism, so that each of the first supporting structure and each of the second supporting structure respectively rotates with respect to each other; and each of the first supporting structure, each of the second supporting structure and the linkage structure is folded inwards.

Preferably, the actuation mechanism comprises:
a first actuation structure adjacent to the first correlation structure;
a second actuation structure adjacent to the second correlation structure;
a connection structure respectively connected to the second correlation structure and the first actuation structure;
when the carrier is transformed from the unfolded state into the folded state, the second actuation structure unlocks the second correlation structure so that each of the second supporting structures rotates with respect to each other, and drives the first actuation structure via the connection structure to unlock the first correlation structure so that each of the first supporting structures rotates with respect to each other. Further, the second correlation structure includes:
a first articulation member connected to one of the second supporting structures, wherein the first articulation member is slidably connected to the second actuation structure;
a second articulation member connected to the other second supporting structure, wherein the second articulation member and the first articulation member are coaxially disposed on a first shaft and is rotatable with respect to a first shaft;
wherein when the carrier is transformed from the unfolded state into the folded state, the second actuation structure slides with respect to the first articulation member to unlock the second correlation structure and rotate the first articulation member about the first shaft in a first direction, thereby the second articulation member rotates about the first shaft in a second direction, wherein the first direction is opposite to the second direction.

In some embodiments, the actuation mechanism further comprises an actuating member connected to the second actuation structure; and when the actuating member is subjected to an actuating force the actuating member drives the second actuation structure to slide with respect to the first articulation member.

In some embodiments, the second actuation structure is provided with a locking block; the first articulation member and the second articulation member are provided with a first recess and a second recess respectively; when the second correlation structure is locked, the locking block is inserted into the second groove; and when the second correlation structure is unlocked, the locking block is disengaged from the second groove.

In some embodiments, the connection structure is rotatably connected to the second articulation member; the connection structure is rotatable with respect to the second articulation member when the second articulation member is rotated in the second direction, so that the first actuation structure is driven by the connection structure to unlock the first correlation structure.

In some embodiments, the first articulation member and the second articulation member are respectively provided with a first sliding slot and a second sliding slot which are eccentrically arranged and axially misaligned. The connection structure is provided with a first slide member which is slidable in a third direction; the first slide member is provided with a first protrusion which is insertable into the first sliding slot and is slidable along the first sliding slot and the second sliding slot; when the first articulation member is rotated in the first direction, the first sliding slot is rotated to cause the first protrusion to slide with respect to the first sliding slot and the second sliding slot, respectively, so as to slide the first slide member in the third direction and to rotate the second articulation member in the second direction.

In some embodiments, the connection structure comprises a sliding sleeve on which the first slide member is slidingly arranged; the sliding sleeve is arranged coaxially on the first shaft with the first articulation member and the second articulation member and rotatable with respect to the first shaft; and when the carrier is transformed from the unfolded state into the folded state, the first articulation member and the second articulation member respectively are rotated and are folded towards the sliding sleeve. In some embodiments, the connection structure further comprises:
a sliding sleeve provided with a third sliding slot;
a sliding rod being slidable in the sliding sleeve, wherein the sliding rod is provided with a second protrusion which is slidable in the third sliding slot;
the second articulation member is further provided with an eccentrically arranged third groove in coordination with the second protrusion; and when the second articulation member is rotated, the third groove drives the second protrusion to slide in the third sliding slot.

In some embodiments, the first actuation structure comprises:
a first inclined structure disposed on the sliding rod;
a second inclined structure disposed on the latch and in coordination with the first inclined structure;
the sliding sleeve is provided with a lock slot matched with the latch;
the first correlation structure comprises a first connecting piece, a third articulation member and a fourth articulation member connected to each of the first supporting structures respectively; the first connecting piece is provided with a channel for the sliding sleeve to slide therein; the first connecting piece, the third articulation member and the fourth articulation member are coaxially disposed on a second shaft; the third articulation member and the fourth articulation member are relatively rotatable around the second shaft;
when the sliding rod slides in the sliding sleeve, the first inclined structure exerts a force to the second inclined structure to move the second inclined structure to unlock the latch, so that the first connecting piece slides on the sliding sleeve in a direction close to the second correlation structure so as to relatively rotate the third articulation member and the fourth articulation member.

In some embodiments, the carrier further includes a stopper disposed at the top of the sliding rod to restrict the sliding rod from moving upwards.

In some embodiments, the second correlation structure is provided with a first engagement member adapted to an outer support for engaging the carrier to the outer support or disengaging the carrier from the outer support;
when the carrier is engaged to the outer support and the carrier is in an unfolded state, the horizontal plane on which the bottom of the carrier formed by each of the second supporting structures is located is greater than 40 cm from the bottom of the outer support.

In some embodiments, when the carrier is in the unfolded state, each of the first supporting structure, the linkage structure, and each of the second supporting structure is unfolded respectively to form a receiving space; and a symmetrically arranged bi-mechanical quadrilateral is formed at a side of the carrier.

In some embodiments, the carrier further comprises a grip provided with a second connecting piece rotatably disposed on the second shaft.

Another object of the present invention is to provide a stroller having a carrier as described above.

In order to achieve the above-mentioned object, the technical solution adopted by the present invention is a stroller comprising the followings.

According to the carrier as described above, the second correlation structure is provided with a first engagement member; and
an outer support provided with a second engagement member adapted to the first engagement member, wherein the first engagement member is engaged with the second engagement member to assemble the carrier onto the outer support.

Due to the use of the above technical solution, the present invention has the following advantages over the prior art. The present invention provides a carrier in which each of the first supporting structures, each of the second supporting structures, and the linkage structures are folded inwards during the process from the unfolded state to the folded state, so that the cloth cover provided in the carrier receiving space is received inside without being exposed and soiled.

### BRIEF DESCRIPTION OF THE DRAWINGS

FIG. 1 is a schematic perspective view of a carrier in an unfolded state according to an specific embodiment of the present invention;

FIG. 2 is a structurally schematic side view of the carrier of FIG. 1;

FIG. 3 is a structurally exploded view of the carrier of FIG. 1;

FIG. 4 is an enlarged schematic view of a part A of FIG. 3;

FIG. 5 is a structurally schematic view of the carrier of FIG. 3 from another perspective;

FIG. 6 is an enlarged schematic view of a part B of FIG. 5;

FIG. 7 is a further exploded structure view of the carrier of FIG. 3;

FIG. 8 is an enlarged schematic view of a portion of the components of FIG. 7;

FIG. 9 is a structurally schematic view of the carrier of FIG. 7 from another perspective;

FIG. 10 is an enlarged schematic view of a portion of the components of FIG. 9;

FIG. 11 is a connection schematic view of a first correlation structure, a second correlation structure and an actuation structure;

FIG. 12 is a schematic perspective view of the carrier of FIG. 1 in a state between an unfolded state and a folded state;

FIG. 13 is a schematic side view of the carrier of FIG. 12;

FIG. 14 is a schematic perspective view of the carrier of FIG. 1 in a folded state;

FIG. 15 is a schematic side view of the carrier of FIG. 14;

FIG. 16 is a schematic perspective view of a stroller with the carrier mounted thereon, wherein the carrier is in an unfolded state and the outer support is in a unfolded state;

FIG. 17 is a structurally schematic side view of the stroller of FIG. 16;

FIG. 18 is a schematic perspective view of the stroller after the carrier has been converted to the collapsed state on the basis of FIG. 16;

FIG. 19 is a structurally schematic side view of the stroller of FIG. 18;

FIG. 20 is a schematic perspective view of the stroller after the outer support has been converted to the folded state on the basis of FIG. 18; and

FIG. 21 is a structurally schematic side view of the stroller of FIG. 20;

In the drawings,
1, first supporting structure; 11, first strut; 12, first cross rod;
2, second supporting structure; 21, second strut; 22, second cross rod;
3, first correlation structure; 31, third articulation member; 32, fourth articulation member; 33, first connecting piece; 331, channel;
4, second correlation structure; 41, first articulation member; 411, first groove; 412, first sliding slot;
42, second articulation member; 42a, first part; 42b, second part; 421, second groove; 422, second sliding slot; 423, third groove; 424, first arc-shaped guide slot;
5, linkage structure; 51, linkage rod;
6, actuation mechanism;
61, latch; 611, lock cylinder; 612, second inclined structure;
62, second actuation structure; 621, locking block;
63, connection structure; 631, first slide member; 6311, first protrusion;
632, sliding sleeve body; 6321, third sliding slot; 6322, lock slot;
633, sliding rod; 6331, second protrusion; 6332, first inclined structure;
634, sliding sleeve seat; 634a, seat body; 634b, connecting piece; 6341, fourth groove; 6342, fourth sliding slot; 6343, fifth sliding slot; 6344, second arc-shaped guide slot;
64, brake;
7, first engagement member; 8, grip; 81, second connecting piece;
9, stopper; 91, rod part; 92, head part;
101, first shaft; 102, second shaft;
100, carrier; 200, outer support; 201, second engagement member.

### DETAILED DESCRIPTION OF THE INVENTION

Reference will now be made in detail to the present embodiments of the invention, examples of which are illustrated in the accompanying drawings so that the advantages and features of the invention may be more readily understood by those skilled in the art.

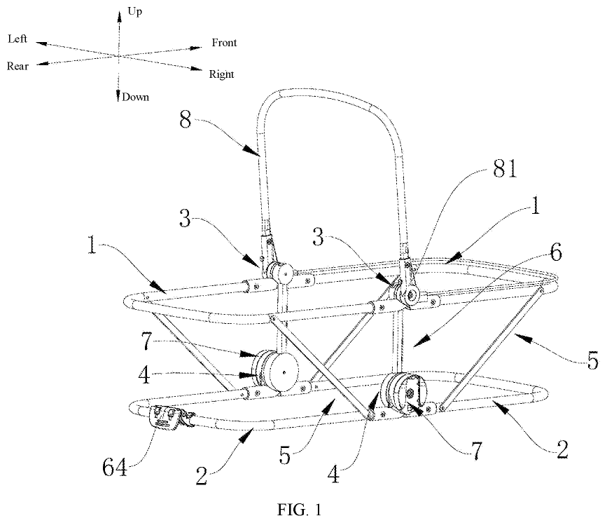

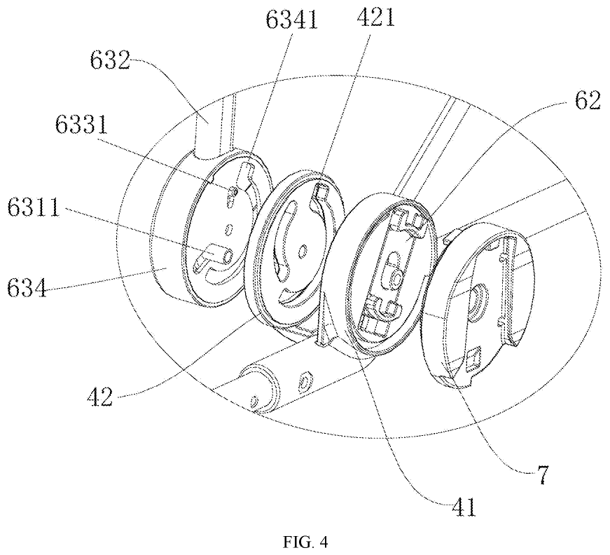

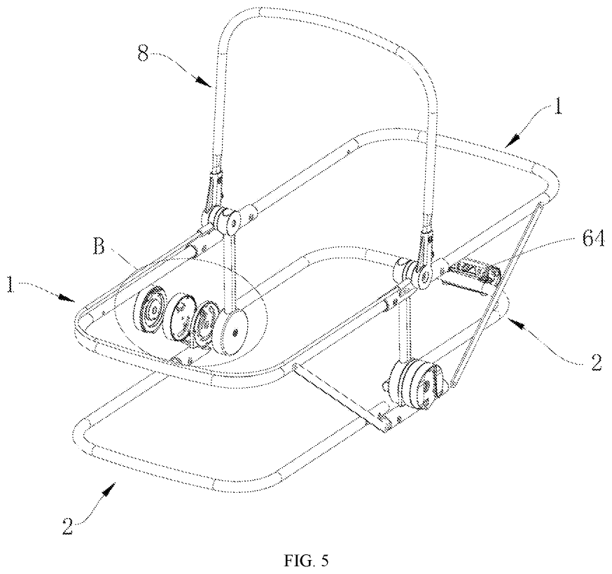

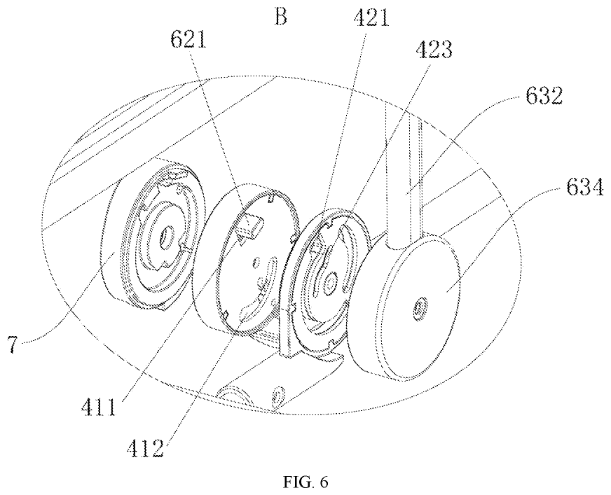

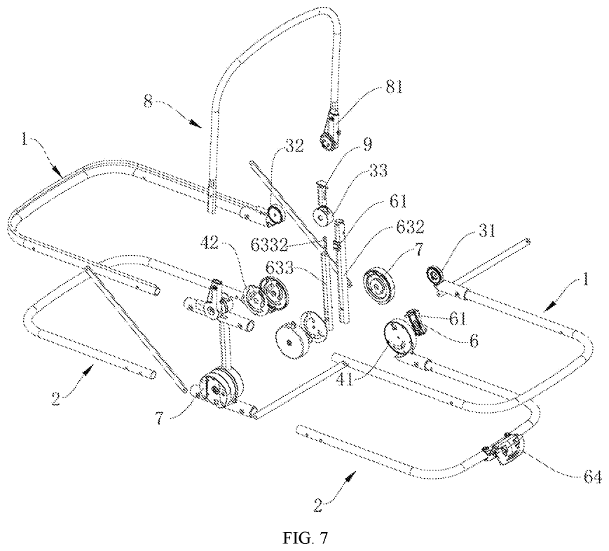

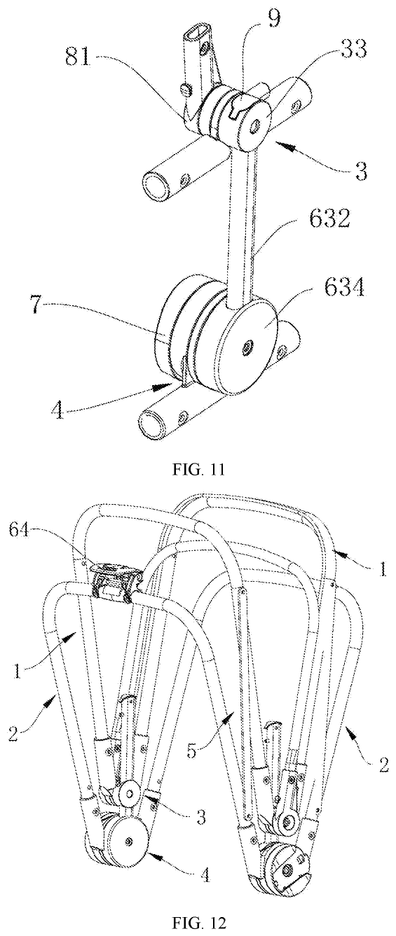

With reference to a carrier shown in FIGS. 1 to 15, the carrier 100 has a folded state and an unfolded state. The carrier comprises a first correlation structure 3 and a second correlation structure 4, and the carrier further comprises:
two first supporting structures 1, wherein each of the first supporting structure 1 is respectively connected to a first correlation structure 3, and each of the first supporting structure 1 is rotatable with respect to each other;
two second supporting structures 2, wherein each of the second supporting structures 2 is respectively connected to the second correlation structure 4, and each of the second supporting structures 2 is rotatable with respect to each other;
a linkage structure 5 disposed between the first supporting structure 1 and the second supporting structure 2 and movable with respect to at least one of the first supporting structure 1 and the second supporting structure 2;
an actuation mechanism 6, wherein the actuation mechanism 6 is coupled to the first correlation structure 3 and the second correlation structure 4; when the carrier is in an unfolded state, the first correlation structure 3 and the second correlation structure 4 are locked by the actuation mechanism 6 so as to position the relative positions of each first supporting structure 1 and the second supporting structure 2; when the carrier is transformed from the unfolded state into the folded state, the first correlation structure 3 and the second correlation structure 4 are unlocked by the actuation mechanism 6, so that each of the first supporting structure 1 and the second supporting structure 2 respectively rotates with respect to each other; and each of the first supporting structure 1, each of the second supporting structure 2 and the linkage structure 5 are folded inwards.

When the carrier is in an unfolded state, each of the first supporting structures 1, the linkage structure 5 and each of the second supporting structures 2 respectively extend to form an receiving space, and a symmetrically arranged bi-mechanical quadrilateral is formed on the side of the carrier, so that the carrier has good stability and bearing capacity in the unfolded state. Also, each part of the mechanical quadrilateral constitutes relative movement, so that it is easy to store and fold the carrier, and the carrier is convenient to switch between the unfolded state and the folded state. The cloth cover is provided inside the receiving space. When the carrier is transformed into a folded state, since each of the first supporting structure 1, each of the second supporting structure 2 and the linkage structure 5 are folded inwards, the cloth cover is retracted inside, so that the cloth cover is prevented from being exposed and being easily soiled.

Referring to FIGS. 1 to 15, in the present embodiment, reference is made to the front, rear, left, right, upper and lower directions of the infant carried in the carrier when the carrier is in an unfolded state, various orientations of the carrier are schematically indicated as shown in FIG. 1. The detailed structure of the carrier will be described with reference to the orientations.

When the carrier is in the unfolded state, one first supporting structure 1, a first correlation structure 3 and the other first supporting structure 1 are sequentially distributed along the front-rear direction. One second supporting structure 2, a second correlation structure 4 and the other second supporting structure 2 are sequentially distributed in the front-rear direction, and two first supporting structures 1 are located above the two second supporting structures 2. A first correlation structure 3 is located above the second correlation structure 4.

Each of the first supporting structures 1 is a U-shaped rod, and comprises two first struts 11 respectively arranged on the left and right sides and extending in the front-rear direction, and a first transverse rod 12 fixedly arranged between one ends of the first struts 11 on the two sides. Each of the second supporting structures 2 is also a U-shaped rod, and comprises two second struts 21 respectively arranged on the left and right sides and extending in the front-rear direction, and a second cross rod 22 fixedly arranged between one ends of the second struts 21 on the both sides. The first correlation structure 3, the second correlation structure 4 and the actuation mechanism 6 all have two groups respectively arranged on the left and right sides, wherein on the left and right sides of the carrier, the other ends of the two first struts 11 are connected via the first correlation structure 3, the other ends of the two second struts 21 are connected via the second correlation structure 4, and the actuation mechanism 6 is disposed between the first correlation structure 3 and the second correlation structure 4.

The linkage structure 5 comprises a plurality of linkage rods 51. A total of four linkage rods 51 are provided on the left and right sides of the carrier, and one linkage rod 51 is rotatably connected between the first strut 11 and the second strut 21 at a corresponding position. Specifically, the upper part of the linkage rod 51 is pivotally connected to the first strut 11, and the lower part of the linkage rod 51 is pivotally connected to the second strut 21. In the front-rear direction, the distance between the upper part of the linkage rod 51 and the first correlation structure 3 is greater than the distance between the lower part of the linkage rod 51 and the second correlation structure 4.

With reference to the figures, the actuation mechanism 6 comprises a first actuation structure, a second actuation structure 62 and a connection structure 63, where the first actuation structure is adjacent to the first correlation structure 3; the second actuation structure 62 is adjacent to the second correlation structure 4; and the connection structure 63 respectively connects the second correlation structure 4 and the first actuation structure. When the carrier is transformed from the unfolded state into the folded state, the second actuation structure 62 unlocks the second correlation structure 4 such that the second supporting structures 2 rotate with respect to each other, and drives the first actuation structure via the connection structure 63 to unlock the first correlation structure 3. Thus, the first supporting structures 1 rotate with respect to each other.

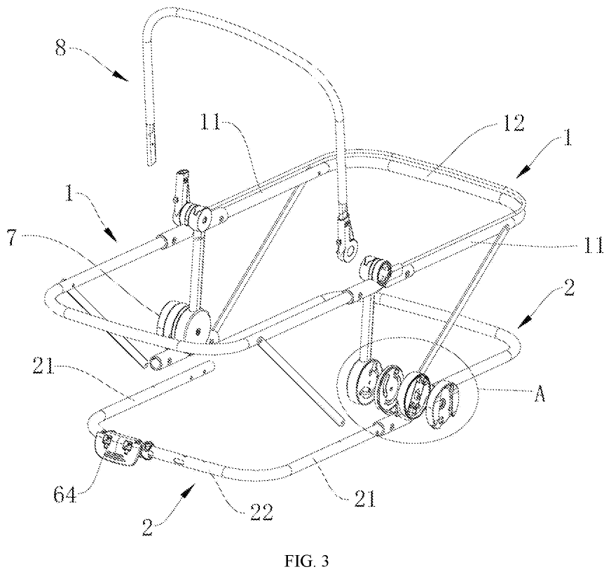

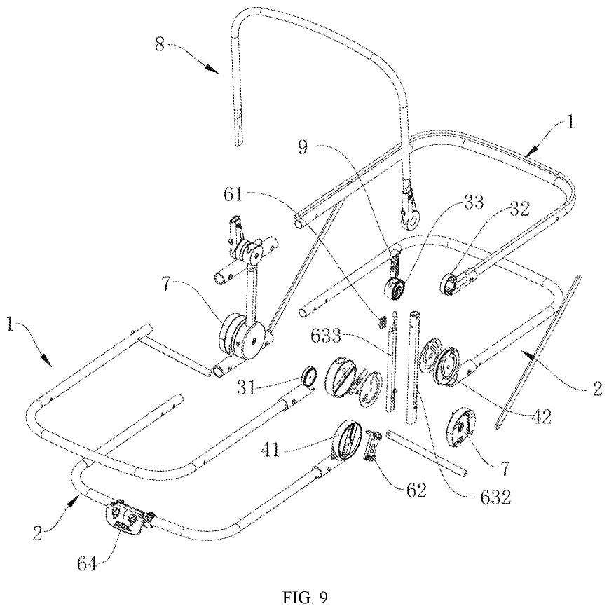

In particular, with reference to FIGS. 3 to 11, the second correlation structure 4 comprises a first articulation member 41 connected to one of the second supporting structures 2, and a second articulation 42. The first articulation member 41 is slidably connected to a second actuation structure 62. The second articulation member 42 is connected to another second supporting structure 2. The second articulation member 42 and the first articulation member 41 are coaxially disposed on a first shaft 101, and may rotate with respect to the first shaft 101. When the carrier is transformed from an unfolded state into a folded state from, the second actuation structure 62 slides with respect to the first articulation member 41 so as to unlock the second correlation structure 4, so that the first articulation member 41 rotates in a first direction around the first shaft 101, and then drives the second articulation member 42 to rotate in a second direction around the first shaft 101, where the first direction is opposite to the second direction. As seen in the perspective of FIG. 9, the first direction is clockwise and the second direction is counterclockwise.

In the present embodiment, the second actuation structure 62 is in the form of a slide block, and is slidably disposed on the first articulation member 41 along an axial direction perpendicular to the first shaft 101. The second actuation structure 62 is provided with a locking block 621. The first articulation member 41 is provided with a first groove 411. The second articulation member 42 is provided with a second groove 421. The second articulation member 42 is further provided with a first arc-shaped guide slot 424 in communication with the second groove 421, and the first arc-shaped guide slot 424 is located radially inside the second groove 421. The locking block 621 passes through the first groove 411 and is inserted in the second groove 421 or the first arc-shaped guide slot 424, where when the second correlation structure 4 is locked, the locking block 621 is inserted in the second groove 421. When the second correlation structure 4 is unlocked, the locking block 621 disengages from the second groove 421 and into the first arc-shaped guide slot 424 and may slide relatively along the first arc-shaped guide slot 424, so that the first articulation member 41 and the second articulation member 42 may rotate about the first shaft 101.

The actuation mechanism 6 further comprises an actuating member 64, which is connected to the second actuation structure 62. When the actuating member 64 is subjected to an actuating force, the actuating member 64 drives the second actuation structure 62 to slide with respect to the first articulation member 41. Here, the actuating member 64 is disposed on the second supporting structure 2 connected to the first articulation 41 and is connected to the second actuation structure 62 by means of a traction cable (not shown in the figures) which is arranged in the rod cavity of the second supporting structure 2.

The connection structure 63 is rotatably connected to the second articulation member 42. When the second articulation member 42 rotates in the second direction, the second articulation member 42 rotates with respect to the connection structure 63, so that the first actuation structure is driven by the connection structure 63 to unlock the first correlation structure 3.

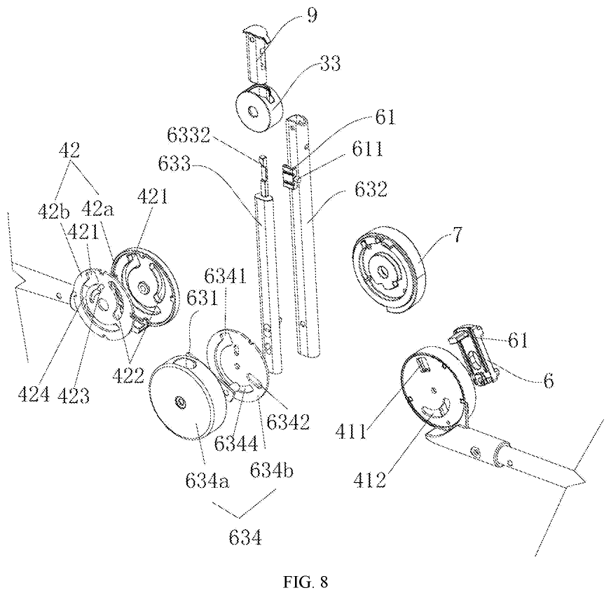

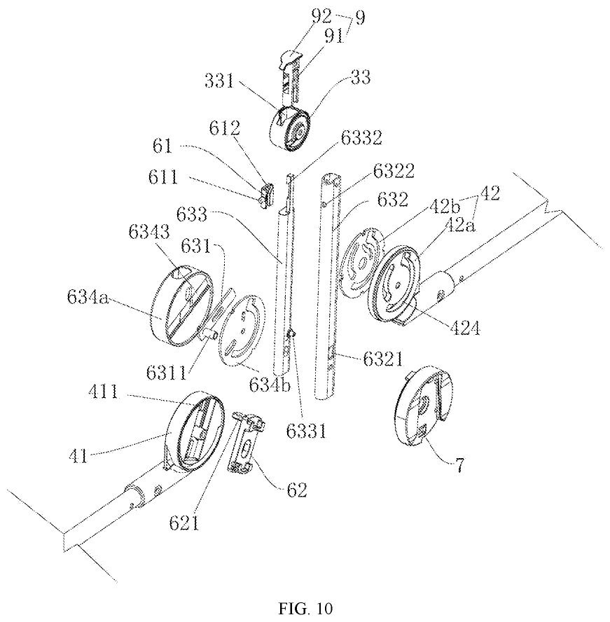

With reference to FIGS. 8 and 10, the first articulation member 41 and the second articulation member 42 are respectively provided with a first sliding slot 412 and a second sliding slot 422 which are eccentrically arranged and axially misaligned. The connection structure 63 is provided with a first slide member 631 which can slide in a third direction; the first slide member 631 is provided with a first protrusion 6311 which may be inserted into the first sliding slot 412 and the second sliding slot 422 and may slide along the first sliding slot 412 and the second sliding slot 422. When the first articulation member 41 rotates in the first direction, the first sliding slot 412 rotates therewith. The first protrusion 6311 is driven to slide with respect to the first sliding slot 412 and the second sliding slot 422 respectively so that the first slide member 631 slides in a third direction, so that the second articulation member 42 rotates in a second direction, and the first articulation member 41 and the second articulation member 42 rotate and close towards the connection structure 63 respectively, where the third direction is perpendicular to the axial direction of the first shaft 101.

The connection structure 63 further comprises a sliding sleeve. A first slide member 631 is slidably disposed on the sliding sleeve. The sliding sleeve is disposed on the first shaft 101 coaxially with the first articulation member 41 and the second articulation member 42 and may rotate with respect to the first shaft 101. When the carrier is transformed from the unfolded state into the folded state, the first articulation member 41 and the second articulation member 42 are respectively rotated and folded towards the sliding sleeve.

In the present embodiment, as shown in FIGS. 3 to 11, the sliding sleeve comprises a sliding sleeve body 632 and a sliding sleeve seat 634, where the sliding sleeve seat 634 is in the shape of a joint which is provided on the first shaft 101, and the sliding sleeve seat 634 is locked and unlocked with respect to the first articulation member 41 and the second articulation member 42 via the second actuation structure 62.

Here, the sliding sleeve seat 634 comprises a seat body 634a and a connecting sheet 634b. The seat body 634a is provided with a fifth sliding slot 6343. The body portion of the first slide member 631 is slidingly provided in the fifth sliding slot 6343. The connecting sheet 634b axially restricts the first slide member 631 in the fifth sliding slot 6343. The connecting sheet 634b is provided with a fourth sliding slot 6342, and the first protrusion 6311 passes through the fourth sliding slot 6342 on the connecting sheet 634b and is then inserted into the first sliding slot 412 and the second sliding slot 422.

The connecting sheet 634b is further provided with a fourth groove 6341 and a second arc-shaped guide slot 6344, where the fourth groove 6341 is located radially outside the second arc-shaped guide slot 6344 and the two are in communication with each other. When the second correlation structure 4 is locked, the locking block 621 is also inserted in the fourth groove 6341. When the second association structure 4 is unlocked, the locking block 621 disengages from the fourth groove 6341, enters the second arc-shaped guide slot 6344 and may slide relatively along the second arc-shaped guide slot 6344, so that the first articulation member 41, the second articulation member 42 and the sliding sleeve seat 434 may rotate with respect to each other around the first shaft 101.

The sliding sleeve body 632 is rod-shaped and extends in the up-down direction. The sliding sleeve body 632 is fixedly provided on the sliding sleeve seat 634, and the sliding sleeve body 632 is provided with a third sliding slot 6321 extending in the up-down direction. The connection structure 63 further comprises a sliding rod 633 which also extends in an up-and-down direction and is provided in the sliding sleeve body 632 and may slide up and down in the sliding sleeve body 632. The sliding rod 633 is provided with a second protrusion 6331 which may slide in the third sliding slot 6321. The second articulation member 42 is further provided with a third groove 423 which is matched with the second protrusion 6331 and is eccentrically arranged. When the second articulation member 42 rotates with respect to the sliding sleeve, the third groove 423 drives the second protrusion 6331 to slide in the third sliding slot 6321, so that the sliding rod 633 correspondingly slides in the up-down direction, thereby driving the first actuation structure to unlock the first correlation structure 3. Here, in order to facilitate the processing of the second articulation member 42, the second articulation member 42 comprises a first part 42a and a second part 42b, where the first part 42a is connected to the second supporting structure 2, the second part 42b is a disc-shaped iron sheet, and the two parts are fixed with each other to form the second articulation member 42. The first part 42a and the second part 42b are both provided with a second groove 421 and a first arc-shaped guide slot 424, and a second sliding slot 422. Only the second part 42b is provided with a third groove 423. The third groove 423 comprises two sections connected in the length direction. One segment is an arc-shaped groove with the first shaft 101 as a rotation center, and the other segment is an eccentric groove provided eccentrically. When the second protrusion 6331 slides in the eccentric groove, the sliding rod 633 is driven to move up and down so as to enable the first linkage structure 3 to be unlocked. When the second protrusion 6331 slides in the arc-shaped groove, the second protrusion 6331 provides a guide for the sliding rod 633 when rotating with respect to the first articulation 41 and the second articulation 43.

In this embodiment, the connection structure 63 further includes a latch 61 slidably provided in the sliding sleeve body 632 in a direction perpendicular to the sliding direction of the sliding rod 633. The first actuation structure comprises a first inclined structure 6332 and a second inclined structure 612, where the first inclined structure 6332 is provided on the sliding rod 633, and is specifically provided on the upper part of the sliding rod 633. The second inclined structure 612 is provided on the latch 61, and the above-mentioned first inclined structure 6332 and the second inclined structure 612 cooperate with each other. The two can be specifically provided as a slope or a protrusion structure which has an inclined surface and may cooperate with each other.

The sliding sleeve body 632 is further provided with a lock slot 6322 matched with the latch 61. The latch 61 is provided with a locking post 611 which may be inserted into the lock slot 6322. The locking post 611 is inserted into the lock slot 6322 by means of the sliding fit. The first correlation structure 3 comprises a first connecting piece 33, and a third articulation member 31 and a fourth articulation member 32 respectively connected to each first supporting structure 1. The first connecting piece 33 is provided with a channel 331 for the sliding sleeve body 632 of the sliding sleeve to slide therein. The first articulation member 33, the third articulation member 31 and the fourth articulation member 32 are coaxially disposed on a second shaft 102. The third articulation member 31 and the fourth articulation member 32 are relatively rotatable around the second shaft 102. The first connecting member 33 is further provided with a lock slot (not shown) into which the lock cylinder 611 may be inserted. When the lock cylinder 611 is inserted into the lock slot, the latch 61 is locked so that the first connecting member 33 is fixed with respect to the sliding sleeve body 632, and the first correlation structure 3 is also locked.

As the sliding rod 633 slides within the sliding sleeve body 632, the first inclined structure 6332 exerts a force to the second inclined structure 612 to cause the second inclined structure 612 to move, thereby causing the latch 61 to unlock, and allowing the first connecting piece 33 to slide on the sliding sleeve body 632 of the sliding sleeve in a direction towards the second correlation structure 4, thereby causing the third articulation member 31 to rotate with respect to the fourth articulation member 32.

The carrier further comprises a stopper 9. The stopper 9 is provided on the top of the sliding rod 633 to limit the upward movement of the sliding rod 633, and specifically has a rod part 91 which may be inserted into the rod cavity of the sliding sleeve body 632, and a head part 92 at the top end of the rod part 91. The outer diameter of the head part 92 is greater than that of the rod part 91 so as to prevent the head part from sliding down into the rod cavity of the sliding sleeve body 632. The shape of the channel 331 of the first connecting piece 33 conforms to the shape of the head part 92, and the head part 92 is correspondingly and cooperatively inserted into the channel 331 in the unfolded state of the carrier.

The carrier further comprises a grip 8. The grip 8 is provided with a second connecting member 81. The second connecting member 81 is rotatably disposed on a second shaft 102. The second connecting piece 81 may be arranged to be lockable with respect to the first correlation structure 3 so as to be able to remain extending in an up-and-down direction when the carrier is in the unfolded state, facilitating a user to lift the carrier by means of the grip 8.

The second correlation structure 4 is further provided with a first engagement member 7 adapted to the outer support 200 so as to be able to engage the carrier to the outer support 200 or to detach the carrier 100 from the outer support 200. In this embodiment, the first articulation member 7 is fixed to a side of the first articulation member 41 facing away from the second articulation member 42.

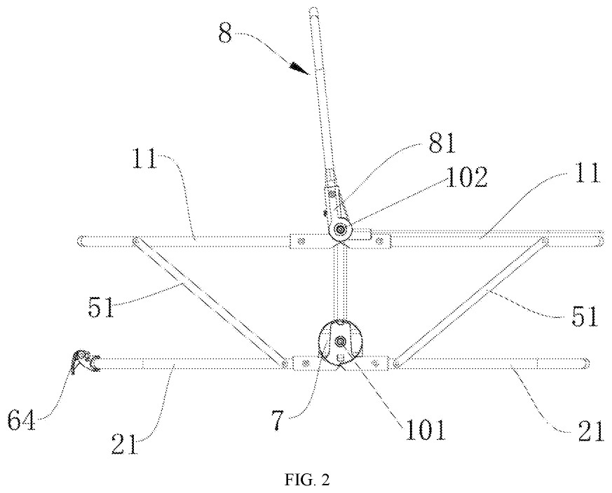

With reference to FIGS. 1 and 2, the carrier is in an unfolded state. Two first supporting structures 1 are unfolded with respect to a first correlation structure 3 in a front-rear direction. Two second supporting structures 2 are located below the first supporting structure 1 and are deployed with respect to a second correlation structure 4 in a front-rear direction. Each linkage rod 51 of the linkage structure 5 is supported between a corresponding first strut 11 and a second strut 21 on each of left and right sides. A first actuation structure and a second actuation structure 62 in an actuation mechanism 6 respectively lock the first correlation structure 3 and the second correlation structure 4. The first supporting structure 1, the second supporting structure 2 and the linkage structure 5 enclose an receiving space for an infant to lie on. The user can lift the carrier by lifting the grip 8.

When it is desired to fold the carrier, the operator operates the actuating member 64, which drives the second actuation structure 62 to slide with respect to the first articulation member 41, so that the first articulation member 41, the second articulation member 42 and the sliding sleeve seat 634 are unlocked from each other and may rotate with respect to each other about the first shaft 101. Subsequently, the first articulation member 41 is driven to rotate in a first direction, the second supporting structure 2 connected to the first articulation member 41 rotates towards the sliding sleeve body 633, and the second articulation member 42 is linked to rotate in a second direction, so that the second supporting structure 2 connected to the second articulation member 42 also rotates towards the sliding sleeve body 633. In the process described above, the second protrusion 6331 slides in the third sliding slot 6321, so that the sliding rod 633 slides correspondingly downwards, and the first inclined structure 6332 on the upper part of the sliding rod 633 acts on the second inclined structure 612 on the latch 61, so that the latch 61 slides and thus the first correlation structure 3 is unlocked.

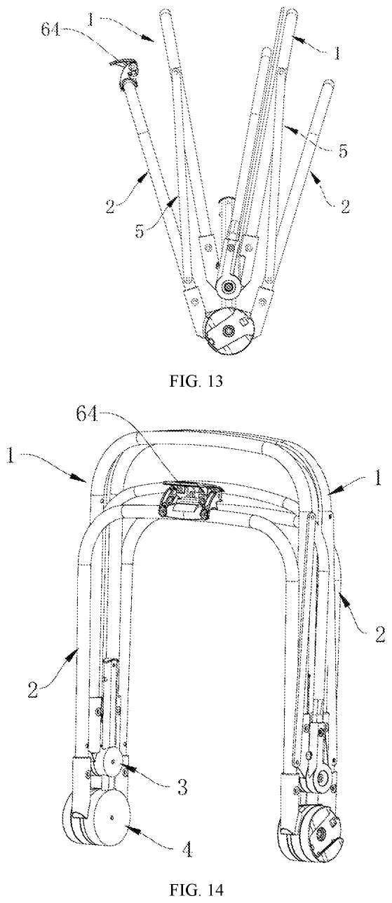

The continued application of force drives the second supporting structure 2 connected to the first articulation member 41 to rotate in a first direction. Under the action of the linkage structure 5, the first supporting structure 1 is linked to rotate with respect to the first correlation structure 3, and then the first correlation structure 3 slides downwards integrally along the sliding sleeve body 633, so that the two first supporting structures 1 are relatively folded on the inner sides of the two second supporting structures 2, as shown in FIGS. 12 and 13.

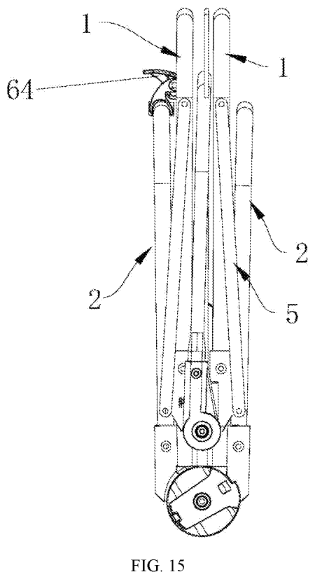

The carrier in a folded state is as shown in FIGS. 14 and 15. The first correlation structure 3 and the second correlation structure 4 are close together in an up-and-down direction. A second supporting structure 2, a first supporting structure 1, a sliding sleeve body 633, another first supporting structure 1 and another second supporting structure 2 are folded in sequence. After being folded, the structure is compact and the appearance is flat. The cloth sleeve provided in the receiving space is received inside without being exposed.

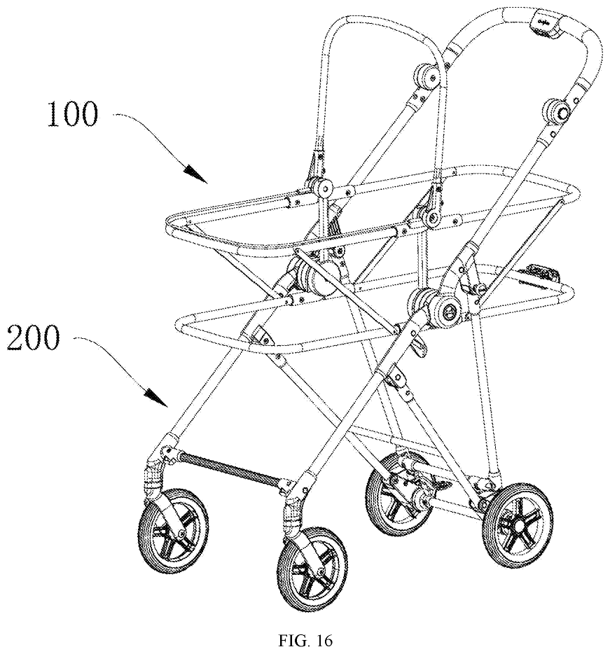

As shown in FIG. 16 to FIG. 21, a stroller on which the carrier 100 as described above is grafted is provided. The outer support 200 of the stroller is a stroller frame, and a second engagement member 201 adapted to the first engagement member 7 is provided on the outer support 200. By connecting the first engagement member 7 and the second engagement member 201, the carrier 100 may be mounted on the outer support 200.

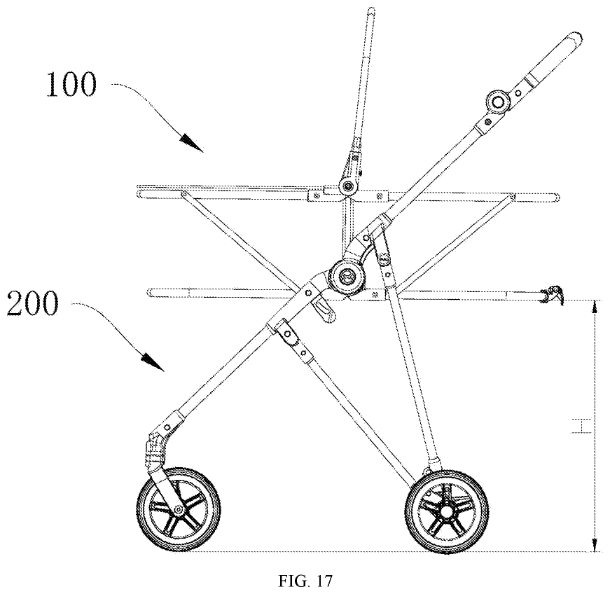

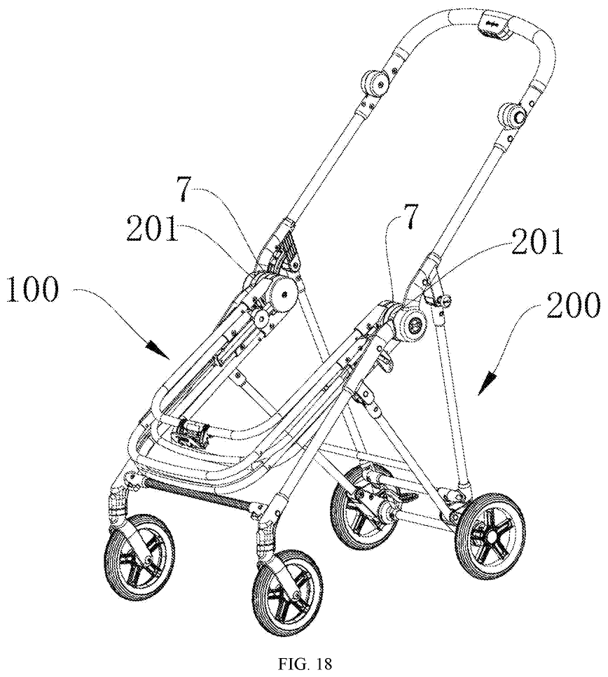

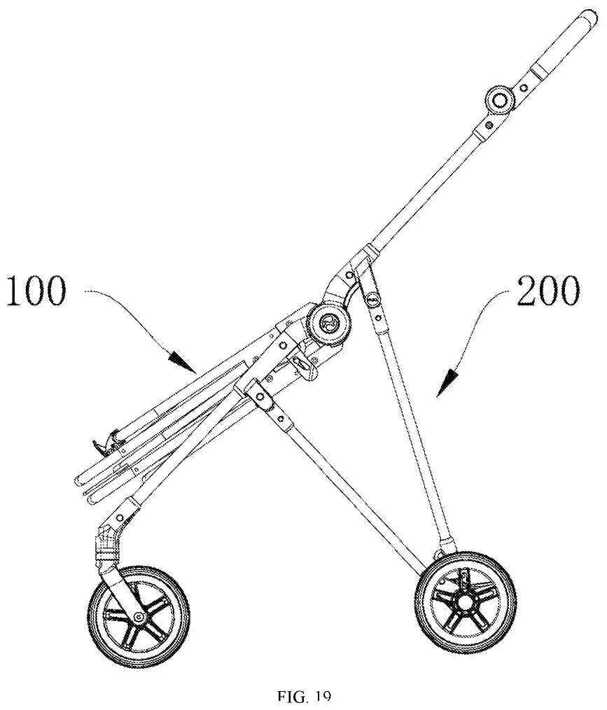

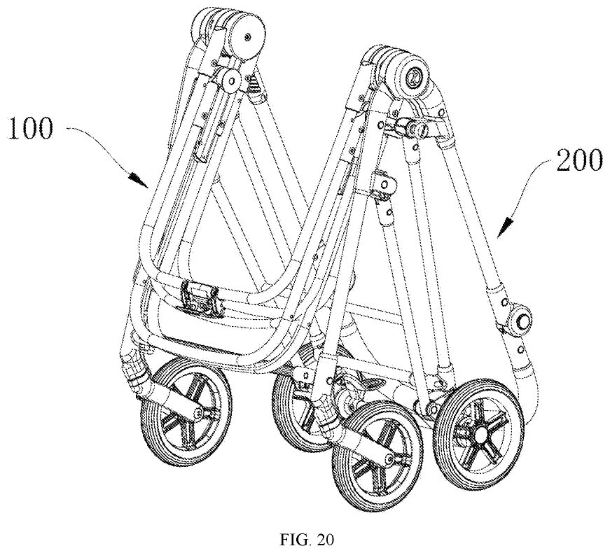

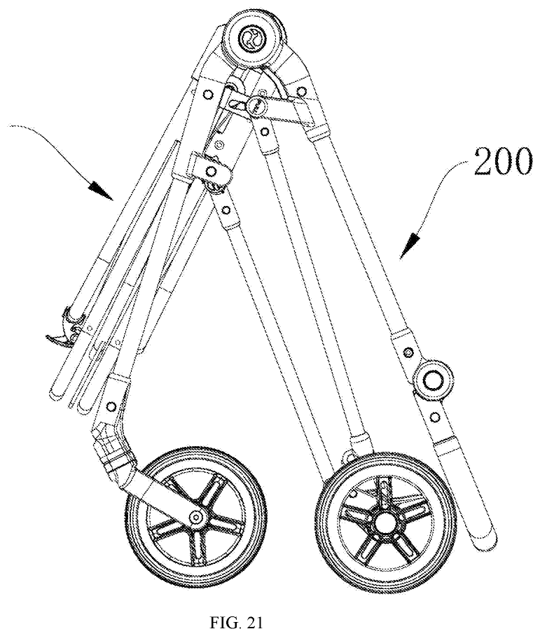

As shown in FIGS. 16 and 17, the carrier 100 is mounted on the outer support 200, the carrier 100 is in an unfolded state, and the distance H between the horizontal plane where the bottom of the carrier formed by each second supporting structure 2 is located and the bottom of the outer support 200 is greater than 40 cm, so that the carrier 100 is not too close to the ground, reducing dust caused by the ground, and facilitating the communication between the stroller personnel and the passengers. When it is required to fold the stroller, as shown in FIGS. 18 and 19, the carrier 100 is converted into a folded state and folded with the front bar of the outer support 200, and then the outer support 200 is folded so that the carrier 100 is received at the front side of the folded outer support 200, as shown in FIGS. 20 and 21.

The above-described embodiments are merely illustrative of the technical concepts and features of the present invention, and are intended to enable those skilled in the art to understand and practice the present invention and are not intended to limit the scope of the present invention. It is intended that the present invention cover the modifications and variations of this invention provided they come within the scope of the appended claims and their equivalents.

1. A carrier, wherein the carrier has a folded state and an unfolded state, the carrier comprising a first correlation structure and a second correlation structure, the carrier further comprising:
two first supporting structures, wherein each of the first supporting structures is respectively connected to the first correlation structure, and each of the first supporting structures is rotatable with respect to each other;
two second supporting structures, wherein each of the second supporting structures is respectively connected to the second correlation structure, and each of the second supporting structures is rotatable with respect to each other;
a linkage structure disposed between the first supporting structure and the second supporting structure and movable with respect to at least one of the first supporting structure and the second supporting structure;
an actuation mechanism coupled to the first correlation structure and the second correlation structure, wherein when the carrier is in an unfolded state, the first correlation structure and the second correlation structure are locked by the actuation mechanism to locate the relative positions of each of the first supporting structures and each of the second supporting structures; when the carrier is transformed from the unfolded state into the folded state, the first correlation structure and the second correlation structure are unlocked by the actuation mechanism, so that each of the first supporting structure and each of the second supporting structure respectively rotates with respect to each other; and each of the first supporting structure, each of the second supporting structure and the linkage structure are folded inwards.

2. The carrier according to claim 1, wherein the actuation mechanism comprises:
a first actuation structure adjacent to the first correlation structure;
a second actuation structure adjacent to the second correlation structure;
a connection structure connected to the second correlation structure and the first actuation structure respectively;
when the carrier is transformed from the unfolded state into the folded state, the second correlation structure is unlocked by the second actuation structure so that each of the second supporting structures rotates with respect to each other, and the first actuation structure is driven by the connection structure to unlock the first correlation structure to enable each of the first supporting structures to rotate with respect to each other.

3. The carrier according to claim 2, wherein the second correlation structure comprises:
a first articulation member connected to one of the second supporting structures, wherein the first articulation member is slidably connected to the second actuation structure;
a second articulation member connected to the other second supporting structure, wherein the second articulation member and the first articulation member are coaxially disposed on a first shaft and is rotatable with respect to the first shaft;
wherein when the carrier is transformed from the unfolded state into the folded state, the second actuation structure slides with respect to the first articulation member to unlock the second correlation structure and rotate the first articulation member about the first shaft in a first direction, thereby the second articulation member rotates about the first shaft in a second direction, wherein the first direction is opposite to the second direction.

4. The carrier according to claim 3, wherein the actuation mechanism further comprises an actuating member connected to the second actuation structure; and when the actuating member is exerted by an actuating force, the actuating member drives the second actuation structure to slide with respect to the first articulation member.

5. The carrier according to claim 3, wherein the second actuation structure is provided with a locking block; the first articulation member and the second articulation member are provided with a first recess and a second recess respectively; when the second correlation structure is locked, the locking block is inserted into the second groove; and when the second correlation structure is unlocked, the locking block is disengaged from the second groove.

6. The carrier according to claim 3, wherein the connection structure is rotatably connected to the second articulation member; the connection structure is rotatable with respect to the second articulation member when the second articulation member is rotated in the second direction, so that the first actuation structure is driven by the connection structure to unlock the first correlation structure.

7. The carrier according to claim 6, wherein the first articulation member and the second articulation member are respectively provided with a first sliding slot and a second sliding slot which are eccentrically arranged and axially misaligned; the connection structure is provided with a first slide member which is slidable in the third direction; the first slide member is provided with a first protrusion which is insertable into the first sliding slot and the second sliding slot and is slidable along the first sliding slot and the second sliding slot;
when the first articulation member is rotated in the first direction, the first sliding slot is rotated therewith to drive the first protrusion to slide with respect to the first sliding slot and the second sliding slot respectively, to enable the first slide member to slide in the third direction and enable the second articulation member to rotate in the second direction.

8. The carrier according to claim 7, wherein the connection structure comprises a sliding sleeve on which the first slide member is slidingly arranged; the sliding sleeve, the first articulation member and the second articulation member are arranged coaxially on the first shaft and rotatable with respect to the first shaft; and when the carrier is transformed from the unfolded state into the folded state, the first articulation member and the second articulation member are rotated and folded towards the sliding sleeve respectively.

9. The carrier according to claim 3, wherein the connection structure further comprises:
a sliding sleeve provided with a third sliding slot;
a sliding rod being slidable in the sliding sleeve, wherein the sliding rod is provided with a second protrusion which is slidable in the third sliding slot;
the second articulation member is further provided with an eccentrically arranged third groove in coordination with the second protrusion; and when the second articulation member is rotated, the second protrusion is driven by the third groove to slide in the third sliding slot.

10. The carrier according to claim 9, wherein the first actuation structure comprises:
a first inclined structure disposed on the sliding rod;
a second inclined structure disposed on a latch and coordinated with the first inclined structure;
wherein the sliding sleeve is provided with a lock slot coordinated with the latch;
the first correlation structure comprises a first connecting piece, and a third articulation member and a fourth articulation member respectively connected to each of the first supporting structures; the first connecting piece is provided with a channel for the sliding sleeve to slide therein; the first connecting piece, the third articulation member and the fourth articulation member are coaxially disposed on a second shaft; the third articulation member and the fourth articulation member are relatively rotatable around the second shaft;
when the sliding rod slides in the sliding sleeve, the first inclined structure exerts a force to the second inclined structure to move the second inclined structure to unlock the latch, so that the first connecting piece slides on the sliding sleeve in a direction close to the second correlation structure so as to drive the third articulation member and the fourth articulation member to rotate with respect to each other.

11. The carrier according to claim 9, wherein the carrier further comprises a stopper disposed at the top of the sliding rod to restrict the sliding rod from moving upwards.

12. The carrier according to claim 1, wherein the second correlation structure is provided with a first engagement member adapted to an outer support for engaging the carrier to the outer support or disengaging the carrier from the outer support;
when the carrier is engaged to the outer support and the carrier is in an unfolded state, the horizontal plane on which the bottom of the carrier formed by each of the second supporting structures is located is greater than 40 cm from the bottom of the outer support.

13. The carrier according to claim 1, wherein when the carrier is in the unfolded state, each of the first supporting structure, the linkage structure and each of the second supporting structure is unfolded respectively to form a receiving space; and a symmetrically arranged bi-mechanical quadrilateral is formed at a side of the carrier.

14. The carrier according to claim 1, wherein the carrier further comprises a grip provided with a second connecting piece rotatably disposed on a second shaft.

15. A stroller, wherein the stroller comprises:
the carrier according to claim 1, wherein a first engagement member is disposed on the second correlation structure; and
an outer support provided with a second engagement member adapted to the first engagement member, wherein the first engagement member is engaged with the second engagement member to assemble the carrier onto the outer support.
